(19) United States
(12) Patent Application Publication
(10) Pub. No.: US 2014/0232549 A1
(43) Pub. Date: Aug. 21, 2014

(54) INTEGRATED TERMINAL FOR ADVANCE METERING INFRASTRUCTUE AND METHOD OF CONTROLLING THE SAME

(71) Applicant: WOOAM, INC., Seoul (KR)

(72) Inventors: Bok-Deok SHIN, Gyeonggi-do (KR); Chung-Hee Ryu, Seoul (KR); Young-Jin PARK, Seoul (KR); Sung-Je WOO, Gyeonggi-do (KR); Ki-Sung KIM, Chungcheongnam-do (KR); Sang-Woo PARK, Gyeonggi-do (KR)

(73) Assignee: WOOAM, INC, Seoul (KR)

(21) Appl. No.: 13/699,736

(22) PCT Filed: Nov. 1, 2012
(86) PCT No.: PCT/KR2012/009114

§ 371 Date: Nov. 25, 2012

(30) Foreign Application Priority Data
Nov. 3, 2011 (KR) 10-2011-0114084
Nov. 1, 2012 (KR) 10-2012-0122774

(51) Int. Cl. G01D 4/00

(52) U.S. Cl. CPC G01D 4/002
USPC 340/870.02

(57) ABSTRACT

An integrated terminal for an advanced metering infrastructure (AMI) system based on a home network for a smart grid and a method of controlling the same are disclosed. The integrated terminal is connected between an upper system 10 of an AMI system and a plurality of home appliances 36, respectively, within a home as a power consumer by a predetermined communication unit. The integrated terminal includes a communication module between upper systems serving as an interface for communication with an upper systems 10, a communication module between home appliances 36 serving as an interface for communication with the plurality of home appliances, and a display unit which displays the information received from the upper systems by the communication module between the upper systems, and displays information received from each home appliance by the communication module between the home appliances.

### RELATED APPLICATIONS

This application is the US National Phase of PCT/KR2012/009114, filed on Nov. 1, 2012, under 35 U.S.C. 371 and claims priority to Korean Patent Application Nos. 10-2011-0114084, filed on Nov. 3, 2011 and 10-2012-0122774, filed on Nov. 1, 2012 in the Korean Intellectual Property Office, the entire disclosures of which are incorporated herein by reference.

### BACKGROUND OF THE INVENTION

1. Field of the Invention

The present invention relates to an integrated terminal for an advanced metering infrastructure (AMI) system based on a home network for a smart grid and a method of controlling the same, and more particularly, to an apparatus for providing various types of information regarding energy use, such as energy usage, rate information, and the like, through a single device configured of a combination of the existing energy service interface (ESI) and an in home display (IHD), while observing ZigBee smart energy profile (SEP) that is a wireless communication standard for interlocking an AMI with a home network and a device language message specification (DLMS) that is a communication standard of an electronic power meter system.

2. Description of the Related Art

A smart grid means an intelligent power network and is a next-generation, power network capable of optimizing an energy use by enabling a power supplier and a power consumer to transmit and receive information associated with electricity use in real time, as an intelligent power network that is a combination of an energy network with a communication network by integrating the existing power network with an information communication technology. The smart grid based power network is being developed to cope with a change in production and consumption in real time and in order to implement a smart grid, there is a need to effectively monitor power consumption.

The AMI is a system that can implement bidirectional information exchange between a power consumer and a power producer based on a smart meter, wherein the smart meter based on the AMI provides a basis for optimizing a supply and demand of power by providing a bidirectional information providing function, a home network interlocking function, a power control function, and the like.

FIG. 1 is a diagram illustrating a structure of a power monitoring system within a home of the AMI system that is suggested in a standard system of the ZigBee SEP.

As illustrated in FIG. 1, the AMI system includes an AMI related upper system 10 of an electric power company based on a meter data management system (MDMS), a communication system connecting an electric power company that is a subject of power production and/or a supplier with a smart meter in a home 30 that in a power consumer, and a smart meter 20 serving as a gateway between an outside and an inside of the home 30.

The upper system 10 includes a data concentration unit (DCU) 11 that collects and stores poser consumption information for each home from the smart meter 20 of each home or transmits the collected information to an automated data collection system (ADCS) 12 in real time, the ADCS 12 that collects various types of power consumption information collected through the DCU 11, and a meter data management system (MDMS) 13 that performs processes such as calculation of a power rate for each home, and the like, by performing various types of processes based on various rate information such as progressive rate information for each power consumption unit, and the like, in addition to various types of power consumption information for each home, power production and supply information of a power producer, rate information from the industry that is collected through the DCU 11 and the ADCS 12, and the like.

A home appliance (HA) 33 may be a general home appliance, such as a TV, a refrigerator, a washing machine, an air conditioner, and the like, and the home appliances 33 for a smart grid need to have a smart function.

The smart meter 20 is an apparatus for bidirectional communication between a power supplier and a user while monitoring power consumption in real time.

For the communication, between the upper systems, an Internet network (TCP/IP) power line communication (PLC), and the like, are used and for communication between the smart meter 20 and the ESI 31, ZigBee communication that is one of the general short range communication types may be used. Alternatively, the communication between the smart meter 20 and the DCU 11 is performed by using the device language message specification (DLMS) that is a communication standard of the smart meter and is a protocol for communication between the smart meter 20 and the DCU 11.

ZigBee is a protocol that can be used to build a low power and low scale wireless network. Meanwhile, a media access control (MAC) and a physical layer are regulated as a standard in IEEE 802.15.4 that is an international standard and a standard of an upper layer in regulated in conjunction with ZigBee Alliance.

Further, the communication between the AMI and a home may be performed through an energy service interface (ESI) 31. In addition, the home is provided with an IHD 32 that displays power consumption information, a rate, carbon emission information, and the like, of various home appliances 33 within a home.

The communication between the ESI 31 and the smart meter 20 is performed by the ZigBee SEP.

Various types of information such as power consumption information, rate information, and the like, of various home appliances 33 within a home are displayed in the IHD 32 via the ESI 31 and the total power consumption information, the rate information, and the like, within a home are transmitted to the IHD 32 via the ESI 31 from the upper system 10 and are displayed.

However, the foregoing existing scheme performs all the communications between the smart meter 20 serving as a gateway and the ESI 31 and between the IHD 32 and the home appliances 33 via the ESI 31 and as a result, a communication system is complicated and the definition of interlocking function and role is not clear.

In particular, in the network configuration of the ZigBee SEP, the IHD 32 cannot search the detailed information of the home appliances 33 that participate in the network and the ESI 31 has a control right of the home appliances 33, such that only the simple information such as power consumption information, and the like, can be searched. Further, it is uncertain whether the interlocking between the ESI 31 of the ZigBee SEP and the upper system 10 is defined.

Further, an upgrade of a firmware is not defined in the ZigBee SEP and therefore, the implementation of the function cannot secure compatibility of standards and a remote firmware upgrade requires high reliability but it is difficult for the RF characteristic and the communication mechanism of ZigBee to meet the request.

The system of the related art has problems in that communication capacity is insufficient and the reliability of communication is limited, due to a limitation of the ZigBee communication.

Recently, some of the smart devices that are manufactured by makers of the home appliances 33 are not based on the ZigBee SEP, but instead home appliances performing communications based on WiFi have appeared. In this case, the system of the related art cannot cope with the WiFi based home appliances.

### SUMMARY OF THE INVENTION

The present invention has been made in an effort to solve the above problems of the related art by configuring a network among a smart meter, an upper system, and home appliances by a terminal in which ESI and IHD functions are integrated into one unit, while observing ZigBee SEP that is a communication standard of an international standard and a DLMS that is a communication standard of the smart meter.

Another object of the present invention is to provide an integrated terminal that can be applied to other communication types of home appliances other than ZigBee SEP.

In order to accomplish the foregoing object, according to an aspect of the present invention, there is provided an integrated terminal that is connected between an upper system of an advanced metering infrastructure (AMI) system and a plurality of home appliances, respectively, within a home as a power consumer by a predetermined communication unit, the integrated terminal including: a communication module between upper systems serving as an interface for communication with an upper system; a communication module between home appliances serving as an interface for communication with the plurality of home appliances; and a display unit which displays the information received from the upper systems by the communication module between the upper systems, and displays information received from each home appliance by the communication module between the home appliances.

According to another aspect of the present invention, there is provided a method for controlling an integrated terminal that is connected between an upper system of an AMI system and a plurality of home appliances, respectively, within a home as a power consumer by a predetermined communication unit, the method including: (a) configuring a communication network between a plurality of home appliances within the home as a power consumer and a smart meter; (b) waiting after the step (a); (c) during the waiting in step (b), determining whether a connection/disconnection of home appliances is requested due to the installation or removal of home appliances and if it is determined that the connection/disconnection is requested, returning to the step (a) to reconfigure the communication network, including the home appliances that are additionally connected or disconnected; (d) during the waiting in step (b), determining whether a control of the home appliances is requested and if it is determined that the control of the home appliances is requested, controlling the corresponding home appliances, and (e) in the waiting in step (b), checking data to be displayed on a display device to determine whether the checked data is valid data and if it is determined that the checked data is valid data, displaying the corresponding data on the display device.

According do the foregoing configuration, the exemplary embodiment of the present invention con simplify the communication system that interconnects between the upper system and the lower system, immediately process the user request, and facilitate an upgrade (firmware upgrade) of the integrated terminal within a home from the upper system, thereby solving the lack of communication capacity and the reliability of communication due to the ZigBee communication that is the existing system.

Further, the exemplary embodiments of the present invention can perform communication with home appliances using, for example, WiFi based communications in addition to the ZigBee SEP of the related art, thereby being applicable for various communication types of home appliances.

### BRIEF DESCRIPTION OF THE DRAWINGS

The above objects, features and advantages of the present invention will become more apparent to those skilled in the related art in conjunction with the accompanying drawings. In the drawings;

FIG. 1 is a diagram illustrating a structure of a power monitoring system of an AMI system that is suggested in a standard system of ZigBee SEP of the related art;

FIG. 2 is a diagram illustrating a structure of a power monitoring system of an AMI system according to an exemplary embodiment of the present invention;

FIG. 3 is a functional block diagram illustrating a configuration of an integrated terminal according to an exemplary embodiment of the present invention; and

FIG. 4 is a flow chart illustrating an operation of the integrated terminal according to the exemplary embodiment of the present invention.

### DETAILED DESCRIPTION OF THE INVENTION

Hereinafter, exemplary embodiments of the present invention will be described in detail with reference to the accompanying drawings.

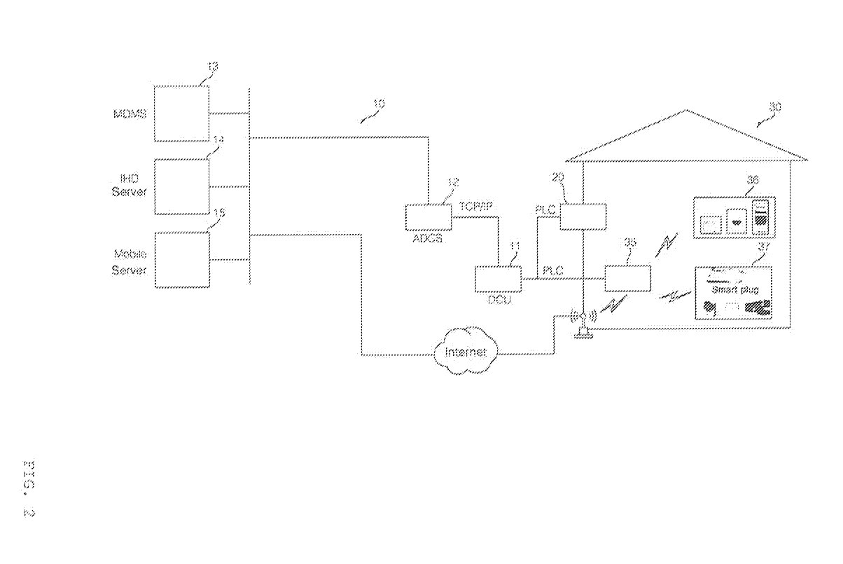

FIG. 2 is a diagram illustrating an overall structure of a power monitoring system of an AMI system according to an exemplary embodiment of the present invention.

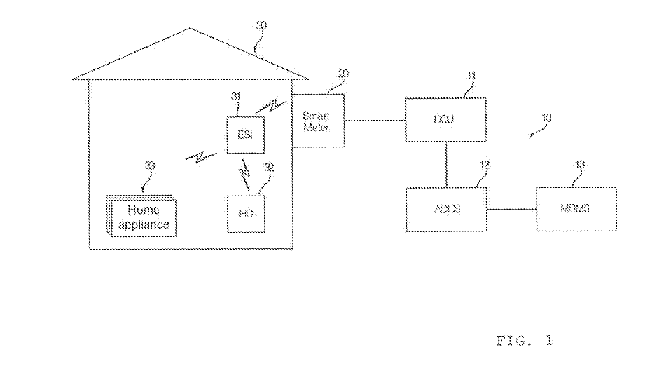

First, as illustrated in FIG. 2, an upper system of an AMI system is the same as the related art, and therefore, like components are denoted by reference numerals of FIG. 1 and a detailed description thereof will be omitted. However, in FIG. 2, an IHD server 14 and a mobile server 15 are added in an upper system 10, but the IHD server 14 is a server that performs a lower function of an MDMS 13 as a server that holds data for displaying information of an integrated terminal 35 performing an IHD function and a mobile server 15 is a server than performs a service using a smart phone, which is not directly associated with the present invention.

In the present specification, the term ‘upper system’ means a system of an upper side, that is, a power supplier side above a smart meter and an integrated terminal, based on the smart meter according to an exemplary embodiment of the present invention and the integrated terminal to be described below and the term ‘lower system’ means a system of a home appliance side within a home that is a lower side, that is, a power consumer below a smart meter and an integrated terminal.

According to the exemplary embodiment of the present invention, improved parts of the related art are that ESI 31 and IHD 32 functions are integrated in an integrated terminal 35 and the integrated terminal 35 is connected to a DCU 11 by a power line communication (PLC) while being connected to an ADCS 12 and the MDMS 13 via an Internet network.

That is, the integrated terminal 35 in which the ESI 31 and IHD 32 functions are integrated is connected to the DCU 11 by the power line communication and thus, thereby the integrated terminal 35 may optionally communicate with the upper system 10 via the DCU 11 and/or the Internet network.

Here, the connection between the integrated terminal 35 and the system 10 may depend on a short range communication network such as WiFi, or the like, within a home 30 and may be directly connected to the Internet network within the home 30.

Further, a home appliance 33 having a smart function among home appliances within the home 30 can be communicably connected directly to the integrated terminal 35 and a home appliance 37 that does not have a smart function can be communicably connected to the integrated terminal 35 via a smart plug.

The integrated terminal 35 according to the exemplary embodiment of the present invention performs both of an interface function for communication between the upper system 10 and the IHD 32 and an interface function for communication between the home appliance 36 (37) that is the ESI 31 function of the related art and the IHD 32 and further performs both of the IHD 32 function of the related art and the ESI 31 function directly controlling the home appliance 36 (37).

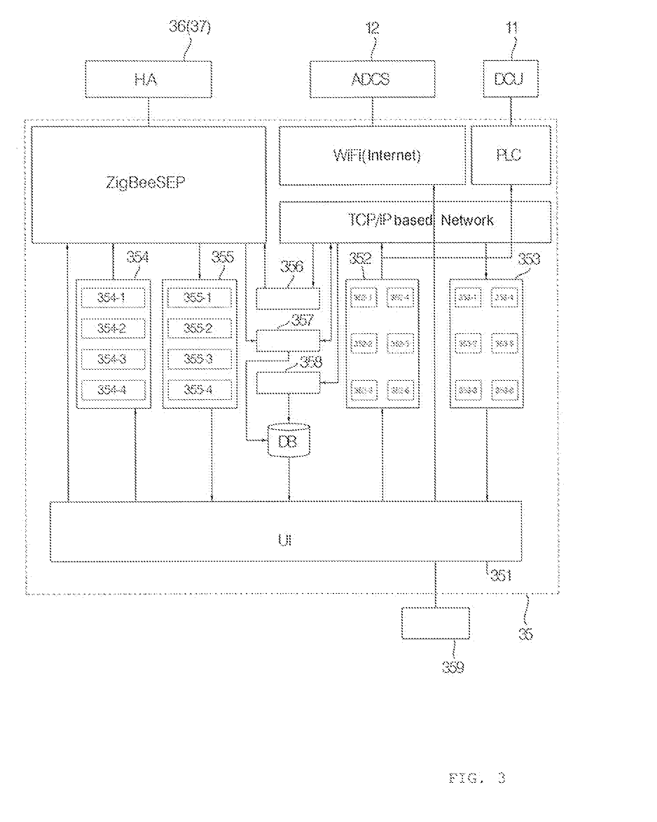

Next, the integrated terminal 35 according to the exemplary embodiment of the present invention will be described with reference to FIG. 3. FIG. 3 is a functional block diagram illustrating a configuration of an integrated terminal according to an exemplary embodiment of the present invention.

As described above, the integrated terminal 35 includes a data request unit 352 that can be communicably connected to the upper system of the AMI system via the Internet or the power line communication, communicably connected to the home appliances 36 (37) that are the lower system by ZigBee SEP or WiFi, and periodically requests necessary data to the upper system 10 according to a user request through a user interface 351 or a time set in an embedded program, a data receiving unit 353 that receives data requested by the data request unit 352 from the upper system 10, a command/data request unit 354 that transmits a command for periodically controlling the home appliances 36 (37) that is the lower system according to the user request through the user interface 351 or the time set in the embedded program or requests data necessary for the home appliances 36 (37), and a command/data receiving unit 355 that receives data requested by the command/data requesting unit 354 frost the home appliances 36 (37).

As the request data that is requested to the upper system 10 by the data request unit 352, there may be, for example, power consumption information (LP) accumulating data 352-1 per a unit time, power consumption statistical information data 352-2, past LP data 352-3, power consumption comparison data 352-4, rate data for each step (progressive rate data) 352-5, other data 352-5, and the like. The data corresponding to the request data as the data received 1 from the upper system 10 by the data receiving unit 353 according to the request by the data request unit 352 is data 353-1 to 353-6 that is accumulated in the MDMS 13 or the ADCS 12 of the upper system 10.

Further, as the command controlling the home appliances 36 (37) by the command/data request unit 354, there may be a command 354-1 that turns on or off each home appliance connected to, for example, the smart plug 37 or a command 354-1 that turns on or off each home appliance 36 having a smart function.

Further, as the request data requested to the home appliances 36 (37) by the command/data request unit 354, there may be, for example, LP data 354-2 for each home appliance 36 (37), current state date 354-3 indicating whether each home appliance 36 (37) is in a current operating state or a stop state, other data 354-4 such as data indicating carbon emission information for each home appliance 36 (37), and the like. The data received from the home appliances 36 (37) by the command/data receiving unit 355 is data 355-1 to 355-4 received from each home appliance 36 (37) as data corresponding to the request data requested by the command/data request unit 354.

As described above, the data request to the upper system 10 or the home appliances 36 (37) by the data request unit 352 or the command/data request unit 354 by the integrated terminal 35 may be periodically performed in a unit of several minutes, for example, 15 minutes, and the like, according to the case in which there is the user request through the user interface 351 or the embedded program.

Further, the integrated terminal 35 includes a display device 359 and each data received from the home appliances 36 (37) of the upper system 10 or the lower system is displayed on the display device 359 and thus, is provided for visual confirmation by a user.

The data request unit 352 and the data receiving unit 353 correspond to a communication module between the upper systems according to the exemplary embodiment of the present invention, the command/data request unit 354 and the command/data receiving unit 355 correspond to the communication module between the home appliances, and the display device 359 corresponds to a display unit.

Further, in addition to the foregoing functions, the integrated terminal 35 may further include an open auto demand request (Open ADR) processing unit 356, a home appliance power consumption information collection unit 357, and a smart meter power consumption information collection unit 358.

The Open ADR is a system that stops the use of the home appliances by directly controlling the home appliances 36 (37) within each home via the integrated terminal 35 in the upper system 10 by, for example, a previous contract between a power supplier and a consumer, for example, when reserved power is insufficient due to a peak of power demand and prevents the occurrence of a power outage in the overall transmission network or distribution network.

The Open ADR processing unit 356 perforce a function of stopping an operation of all or a part of the home appliances 36 (37) by the control from the upper system 10 when a necessity of the Open ADR is generated.

The home appliance power consumption information collection unit 357 performs a function of collecting the power consumption information for each home appliance 36 (37) or for each predetermined period of all the home appliances 36 (37) within the home 30 and transmitting the collected power consumption information to the upper system 10.

The smart meter power consumption information collection unit 358 performs a function of collecting the power consumption information for each home that is held by the smart meters 20 of each home 30 through the DCU 11 or the upper system 10.

Further, the integrated terminal 35 includes a database (DB) and may store the power consumption information for a predetermined period and the power consumption information for each home that are collected by the house appliance power consumption information collection unit 357 and the smart meter power consumption information collection unit 358 in the DB within the integrated terminal 35. In this case, the power consumption information for each predetermined period of the home appliances 36 (37) stored in the DB and the power consumption information for each home held by the smart meter 20 may be displayed by a user request, and the like.

Unlike the data request unit 352 to the command/data receiving unit 355, the Open ADR processing unit 356, the home appliance power consumption information collection unit 357, and the smart meter power consumption information collection unit 358 controls each home appliance 36 (37) by the direct control of the upper system 10 or collects the desired information from each home appliance 36 (37) and the smart meter 20.

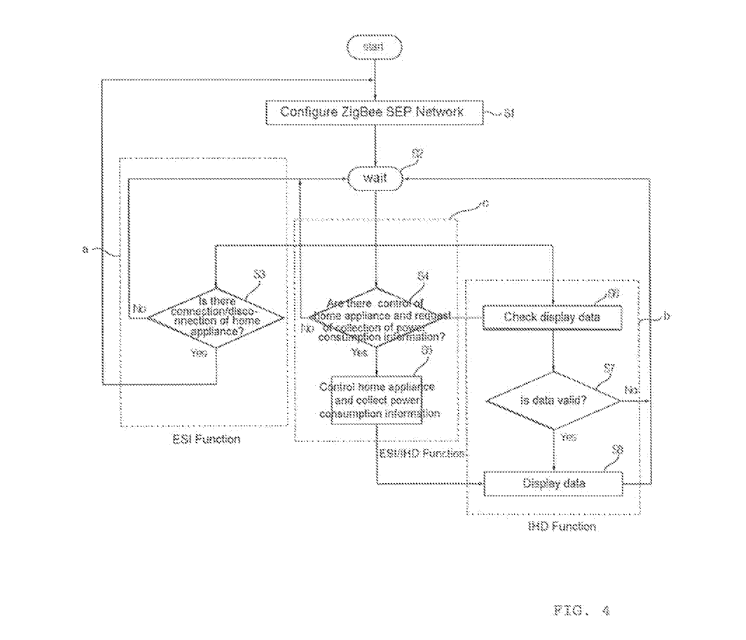

Next, an operation of the integrated terminal 35 according to the exemplary embodiment of the present invention to perform the integrated function of the ESI and the IHD based on the ZigBee SEP will be described with reference to FIG. 4. FIG. 4 is a flow chart illustrating an operation of the integrated terminal according to the exemplary embodiment of the present invention.

First, when a network connected to the upper system 10 is configured simultaneously with the initialization of the system, in step S1, the integrated terminal 35 configures, for example, the ZigBee SEP communication network with the lower home appliances 36 (37) and smart meter (20), and the like, and then, proceeds to step S2 and waits.

Next, during the waiting of step S2, it is determined whether the connection/disconnection of the home appliances are additionally requested to the communication network built in step S1 by, for example, the installation or removal of the home appliances, and the like (step S3). As the determination result, if it is determined that the connection/disconnection is requested from the home appliances (Yes in step S3), the operation returns to step S1 to reconfigure the communication network including the home appliances that are additionally connected or disconnected. If it is determined that there is no connection/disconnection request (No in step S3), the operation returns to step S2 and waits.

Further, during the waiting in step S2, it is determined whether there are the control of the home appliances and the collection request of the power consumption information according to the request from a user or a predetermined period in the embedded program as described above (step S4). As the determination result, if it is determined that there are the control of the home appliances and the collection request of the power consumption information (Yes in step S4), the operation proceeds to step S5 to control the corresponding home appliances or collect the power consumption information and then, the operation proceeds to step S8 to display the results on the display device 359 of the integrated terminal 35 and then, returns to step S2 and waits. If it is determined that there is no control of the home appliances or collection request of the power consumption information (No in step S4), the operation returns to step S2 and waits.

In addition, during the waiting of step S2, the integrated terminal 35 continuously checks the data to be displayed on the display device 359 (step S6) and in step S7, it is determined whether the checked data is valid data. As the determination result, if it is determined that the checked data is valid data (Yes in step S7), the operation proceeds to step S8 to display the corresponding data on the display device 359 and returns to step S2 and waits. If it is determined that the checked data is not valid data (No in step S7), the operation returns to step S2 and waits.

The integrated terminal 35 performs a routine as described above to achieve the function of the integrated terminal 35.

Further, as illustrated in FIG. 4, according to the integrated terminal on the present invention, the ESI function of the related art marked by symbol a, the IHD function of the related art marked by symbol b, and a function of integrating the ESI and the IHD of the related art marked by symbol c are performed by a single apparatus.

As described above, the exemplary embodiment of the present invention configures the network between the smart meter and the home appliances by the integrated terminal in which the ESI and IHD functions of the related art are integrated into one to collect or provide the information and the data through the communication with the home appliances that are the lower system while collecting or providing the information and the data through the communication with the upper system and the user can control the operation of the home appliances by the integrated terminal according to the exemplary embodiment of the present invention or the upper system can directly control the home appliances within each home as a power consumer by the integrated terminal.

Therefore, according to the present invention, it is possible to simplify the communication system that interconnects between the upper system and the lower system, immediately process the user request, and facilitate an upgrade (firmware upgrade) of the smart function of the integrated terminal within a home from the upper system, thereby solving the lack of communication capacity and the reliability of communication due to the ZigBee communication that is the existing system.

Further, the exemplary embodiments of the present invention can perform the communication with home appliances using, for example, WiFi based communications in addition to the ZigBee SEP of the related art, thereby being applicable for various communication types of home appliances.

What is claimed is:

1. An integrated terminal that is connected between an upper system of an advanced metering infrastructure (AMI) system and a plurality of home appliances, respectively, within a home as a power consumer by a predetermined communication unit, the integrated terminal comprising:
a communication module between upper systems serving as an interface for communication with an upper system;
a communication module between home appliances serving as an interface for communication with the plurality of home appliances; and
a display unit which displays the information received from the upper systems by the communication module between the upper systems, and displays information received from each home appliance by the communication module between the home appliances.

2. The integrated terminal of claim 1, wherein information acquired from the upper system by communication by the communication module between the upper systems is at least one of power consumption information accumulating data per a unit time, power consumption statistical information data, past power consumption information data per a unit time, power consumption comparison data, and rate data for each progressive step.

3. The integrated terminal of claim 1, wherein at least one of a command that turns on or off the plurality of home appliances, respectively, acquisition or power consumption data for each home appliance per a unit time, acquisition of current state data indicating whether each home appliance is in a current operation state or stop state, and acquisition of carbon emission data for each home appliance is made by communication by the communication module between the home appliances.

4. The integrated terminal of claim 1, wherein the integrated terminal further comprises at least one of an open auto demand request (Open ADR) processing unit that turns on or off the plurality of home appliances, a home appliance power consumption information collection unit that collects power consumption information of a plurality of home appliances, and a smart meter power consumption information collection unit that collects power consumption information from the smart meter of a home as a power consumer, and
the Open ADR processing unit, the home appliance power consumption information collection unit, and the smart meter power consumption information collection unit are directly controlled by the upper system.

5. The integrated terminal of any one of claims 1 to 3, wherein the communication with the upper system is Internet communication or power line communication, and
the communication between the plurality of home appliances is ZigBee smart energy profile (SEP) or WiFi communication.

6. A method for controlling an integrated terminal that is connected between an upper system of an AMI system and a plurality of home appliances, respectively, within a home as a power consumer by a predetermined communication unit, the method comprising:
(a) configuring a communication network between a plurality of home appliances within the home as a power consumer and a smart meter;
(b) waiting after the step (a);
(c) during the waiting in step (b), determining whether a connection/disconnection of home appliances is requested due to the installation or removal of home appliances and if it is determined that the connection/disconnection is requested, returning to the step (a) to reconfigure the communication network, including the home appliances that are additionally connected or disconnected;
(d) during the waiting in step (b), determining whether a control of the home appliances is requested and if it is determined that the control of the home appliances is requested, controlling the corresponding home appliances, and
(e) in the waiting in step (b), checking data to be displayed on a display device to determine whether the checked data is valid data and if it is determined that the checked data is valid data, displaying the corresponding data on the display device.
